(19) United States
(12) Patent Application Publication
(10) Pub. No.: US 2006/0049617 A1
(43) Pub. Date: Mar. 9, 2006

(54) Inflatable tubular or other cushions particularly useful for torso protection

(76) Inventors: Gregory A. Mowry, Phoenix, AZ (US); Mark Ashley Baldwin, Scottsdale, AZ (US); Gregory Brian Grace, Mesa, AZ (US)

Correspondence Address: John S. Pratt, Esq.;KILPATRICK STOCKTON LLP, Suite 2800, 1100 Peachtree Street, Atlanta, GA, 30309-4530, US

(21) Appl. No.: 10/934,197

(22) Filed: Sep. 3, 2004

(51) Int. Cl. B60R 21/16

(52) U.S. Cl. 280/730.2

(57) ABSTRACT

Inflatable restraints or protective systems are addressed. Included among the restraints and systems are inflatable, braided cushions designed to enhance available protection for the torsos of vehicle occupants, particular when a vehicle is subject to a side-impact collision. The (typically unvented) cushions effectively create their own structure and transfer occupant energy from less tolerant to more tolerant areas of the occupants' bodies.

### FIELD OF THE INVENTION

This application relates to devices for protecting vehicle occupants and more particularly (but not exclusively) to cushions designed to inflate when a vehicle is impacted. The cushions are especially adapted as protective designs when side-impact collisions occur and are intended to reduce likelihood of occupants experiencing injuries to their thoraxes or other portions of their torsos. The cushions may, however, be useful in other circumstances and perform other protective functions too.

### BACKGROUND OF THE INVENTION

Commonly-owned U.S. Pat. No. 5,322,322 to Bark, et al. describes an existing protective system for vehicle occupants. Versions of the system, designed to be mounted along the periphery of a side window of a vehicle (at or near the roof rail), include a braided tube containing a gas generator. As noted in the Bark patent:
When a side impact is detected, the gas generator is ignited, inflating the braided tube. As the braided tube inflates, the diameter of the tube increases and its length decreases. The tube then pulls out of its storage location and forms a taut, semi-rigid structural member across the vehicle's window.
   See Bark, Abstract, 11. 7-12.

Commonly-owned U.S. Pat. No. 6,126,194 to Yaniv, et al. discusses use of the braided tube in the torso section of a seat belt. According to the Yaniv patent:

The inflated braided tube . . . provides a much larger restraint surface area for the occupant's body, which helps to distribute belt load forces. When the inflated braided tube is loaded by the occupant's body, it flattens slightly. This flattening increases the contact area between the body and the braided tube, thus further reducing the stress or load concentration on the occupant. In a side impact the inflated section provides occupant head protection. See Yaniv, col. 4, 11. 1-8. The contents of both the Bark and Yaniv patents are incorporated herein in their entireties by this reference.

U.S. Pat. No. 5,718,450 to Hurford, et al. illustrates an inflatable restraint system having an air bag configured to protect head and thorax regions of an occupant during a side-impact collision. The bag inflates from its bottom,
thus inflating the region adjacent the thorax area of the occupant first. As the thorax area is loaded by the occupant and door intrusion from the impacting vehicle, gas is forced into the head area of the air bag. As the head area is loaded by the occupant, gas is vented to the atmosphere through vents located in the head area of the air bag.
   See Hurford, col. 2, 11. 51-57.

Detailed in U.S. Pat. No. 5,224,732 to Warner, et al., finally, is an inflatable restraint system designed to be mounted on a side door of a vehicle. In the system, an air bag is maintained in position by a cushioning panel. When the air bag deploys, it propels the cushioning panel toward an occupant of the vehicle.

### SUMMARY OF THE INVENTION

The present invention provides alternatives to the designs described in the above-mentioned patents and in commercial use today. Although not necessarily limited to protecting torsos of occupants whose vehicles are engaged in side-impact collisions, the invention is designed in an attempt to provide at least some protection in these circumstances. In particular, whereas most commercially-available thorax-protective devices use a vented bag reacting against the structure of the intruding vehicle to absorb occupant energy created by a crash, the present invention preferably utilizes an unvented inflatable cushion to create its own structure and transfer occupant energy to more force-tolerant areas of the occupants.

Certain embodiments of the invention include an inflatable cushion having one end attached to a seat back and the other to an associated seat pan. The cushion preferably is tubular when inflated and braided as described in the Bark and Yaniv patents. It need not necessarily be so shaped and structured, however. Indeed, in some embodiments, the cushion may be knit, for example, rather than braided.

Assuming that the cushion (or other countermeasure) may generate tension due to its shape and design and contact a vehicle occupant, it effectively can pre-load the occupant before the side- (or obliquely-) impacting vehicle intrudes significantly into the structure of the occupied vehicle. The cushion additionally may affirmatively load, independently of vehicle structure or vehicle intrusion, an occupant's pelvis in-board, reducing the likelihood of (or mitigating effects of) contact and interaction between the occupant and the intruding vehicle. Further products of use of the invention may be to reduce impact force on weaker, less tolerant areas of a body (such as ribs) and, as noted above, distribute it to more tolerant areas (such as pelvises and shoulders).

Among other benefits of versions of the present invention is that they may be deployed very rapidly. Rapid deployment may be effected in part because of the relatively small volume of cushioning material needing to be inflated. The proximity of the cushion to the occupant of the vehicle also may facilitate its rapid use.

Other embodiments of the invention position the inflatable cushion so that it descends from the roof rail of a vehicle. This positioning facilitates energy being transferred to shoulders of occupants. Generally, though, its functions may be similar to those of the embodiments described earlier. Alternatively, a non-inflatable pre-loading device may be utilized. Such a device could be attached to an inflatable component, although it need not necessarily be so attached.

It thus is an optional, non-exclusive object of the present invention to provide protective cushions for persons.

It also is an optional, non-exclusive object of the present invention to provide inflatable cushions for use by occupants of vehicles.

It is another optional, non-exclusive object of the present invention to provide inflatable tubular cushions adapted to pre-load vehicle occupants independent of and before significant intrusion of a vehicle impacting the occupied vehicle from a side or an oblique angle.

It is, moreover, an optional, non-exclusive object of the present invention to provide inflatable cushions adapted to transfer impact forces from some portions of occupants' bodies to other portions.

It is a further optional, non-exclusive object of the present invention to provide inflatable cushions designed to move portions of a body in-board, thereby providing an independent force vector in the same direction as that of an impacting vehicle.

It is yet another optional, non-exclusive object of the present invention to provide inflatable cushions connected to vehicle seats, vehicle roof rails, or both.

Other objects, features, and advantages of the present invention will be apparent to those skilled in the relevant field with reference to the remaining text and the drawings of this application.

### BRIEF DESCRIPTION OF THE DRAWINGS

FIG. 1 is a partially schematized depiction of a system of the present invention showing positioning of a deployed cushion with respect to an occupant of a seat.

FIGS. 2a-2b are partially-schematized, partially cut-away illustrations of the system of FIG. 1, with FIG. 2a depicting an undeployed cushion and FIG. 2b depicting a deployed cushion.

FIGS. 3-5 are generally elevational views of alternative systems of the present invention.

FIGS. 6-7 illustrate an exemplary braided cushion for systems of the present invention, with FIG. 6 showing the cushion in an uninflated state and FIG. 7 detailing portions of an inflated cushion.

### DETAILED DESCRIPTION

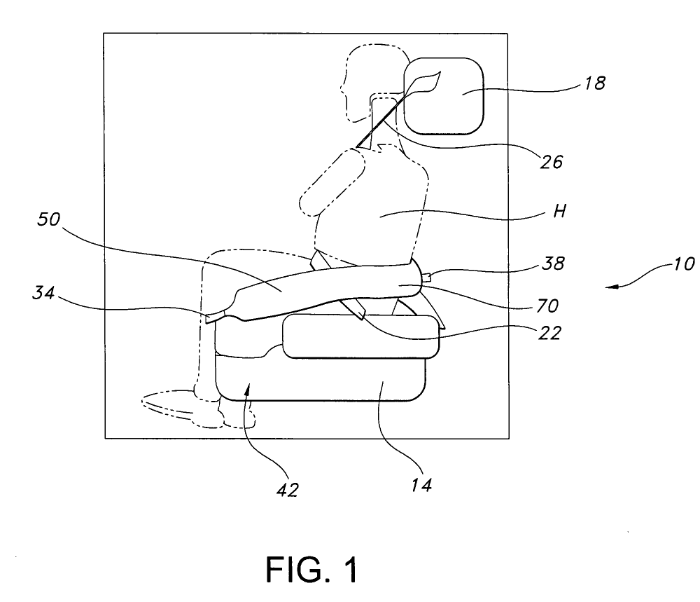

Shown schematically in FIG. 1 is system 10 of the present invention. Also disclosed in FIG. 1 is a representation of a human H in a sitting position, as would occur when human H occupies a vehicle (or other) seat. Additionally depicted in FIG. 1 are portions of the seat, including seat pan or platform 14 and head rest 18, as well as lap belt 22 and shoulder belt 26.

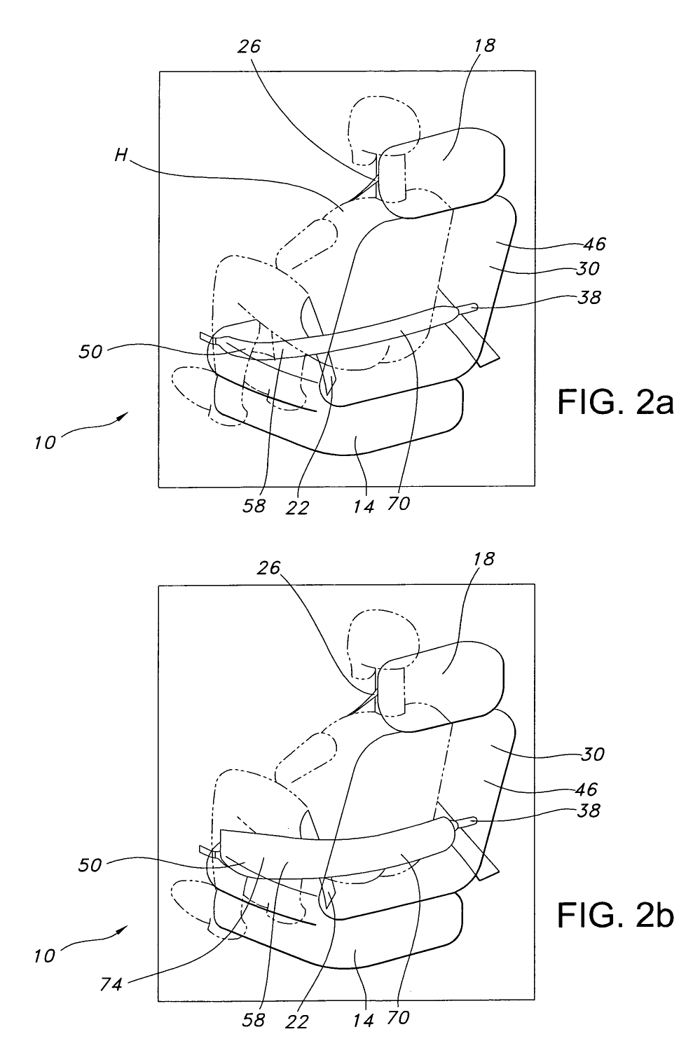

FIGS. 2a-2b similarly illustrate system 10 of the invention together with human H, seat platform 14, head rest 18, lap belt 22, and shoulder belt 26. Further shown in FIGS. 2a-2b is seat back 30 interposed between seat platform 14 and head rest 18. As shown in FIGS. 1 and 2a-2b, system 10 connects to both seat platform 14 and seat back 30.

This connection of system 10 may occur utilizing connector segments 34 and 38 (see also FIG. 7). Segment 34 attaches to seat platform 14, while segment 38 connects to seat back 30. Preferably, segment 34 attaches to out-board side 42 of seat platform 14 and segment 38 attaches to in-board side 46 of seat back 30. Assuming this preferred positioning is depicted in FIGS. 1 and 2a-2b as being within a commercial road vehicle used in the United States, the particular human H illustrated in these figures thus will be occupying a forward-looking position on the driver's side of the vehicle. Segments 34 and 38 may, however, be attached differently than as depicted in FIGS. 1 and 2a-2b—particularly (but not exclusively) when the seat is on the passenger side of a vehicle—and connectors other than segments 34 and 38 may be employed instead.

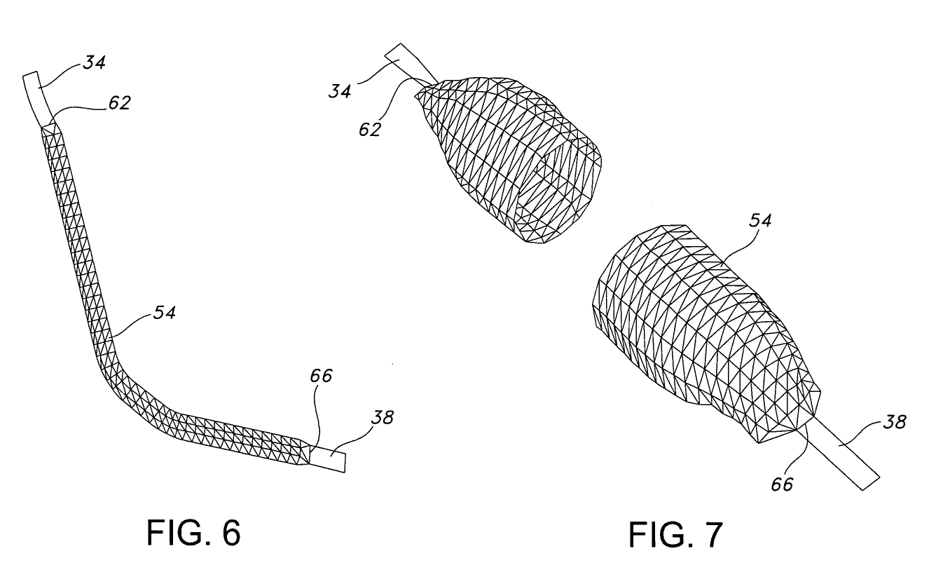

Also forming part of system 10 may be inflatable component 50. In the version shown in FIGS. 1 and 2a-2b, component 50 beneficially includes an elongated tubular structure 54 (see FIGS. 6-7) which may, but need not necessarily, be enclosed within a sheath or other cover 58. An end 62 of component 50 is connected to segment 34, while an opposite end 66 of the component 50 attaches to segment 38.

Structure 54 may be braided as depicted both in FIGS. 6-7 and in the Bark and Yaniv patents. As described in the Yaniv patent, structure 54 may comprise
a braided tube of continuous high-strength fibers (instead of the conventional material used for air bags). The fibers of the braided tube . . . form spirals and change their orientation upon inflation. Prior to inflation, the spirals are stretched-out longitudinally and the tubular restraint has a relatively small diameter . . . . Subsequent to inflation, the spirals are closer together longitudinally and form a relatively large tubular diameter . . . . That is, upon inflation, the braided tube significantly increases its diameter and significantly decreases its length. This contraction occurs because when the tube is inflated, the fibers seek an orientation that allows a lower resultant stress and hence a larger volume within the tube.
   See Yaniv, col. 3, 11. 43-56. FIGS. 2a and 6 illustrate an exemplary structure 54 in an uninflated state, while FIGS. 2b and 7 show the structure 54 when inflated.

Preferably, inflatable component 50 has a portion positioned behind a seated occupant H. This feature of system 10 exists in FIGS. 1 and 2a-2b, with portion 70 of component 50 adjacent segment 38 being so positioned. Although FIGS. 2a-2b illustrate portion 70 being embedded within seat back 30, portion 70 alternatively may be positioned behind (rather than within) the seat back 30. Yet alternatively, portion 70 may be positioned immediately in front of seat back 30 if doing so would not impede seating of occupant H and portion 70 may properly be restrained when inflated.

Activation of system 10 may occur when a vehicle in which occupant H is riding is impacted by another vehicle approaching, for example, from out-board side 42 of seat platform 14. When system 10 is activated, component 50 is deployed, resulting in inflation of structure 54. Such inflation, as noted above, significantly increases the diameter of structure 54 while decreasing its length. These actions tension structure 54 and render it taut, forcing portion 74 against the out-board pelvic region of occupant H. This force effectively loads occupant H independent of the intrusion and prior to complete intrusion of the impacting vehicle, potentially reducing the likelihood or severity of injury in certain crashes. It further may tend to push occupant H in-board, away from the impacting vehicle.

By inducing load on the pelvic region of the occupant H, system 10 tends to reduce—or potentially even eliminate—impact force on other, less force-tolerant areas of the human body (such as, but not limited to, ribs). Moving occupant H in-board in advance of the intruding vehicle structure also reduces the velocity of the occupant H relative thereto. Stated differently, if inflation of portion 74 forces occupant H in-board at, for example, five miles per hour, and the intruding vehicle is impacting the occupied vehicle from the out-board side at, for example, fifteen miles per hour, the relative velocity between the occupant H and the impacting vehicle is only ten miles per hour (rather than fifteen miles per hour, which would be true if occupant H were not caused to move in-board by system 10).

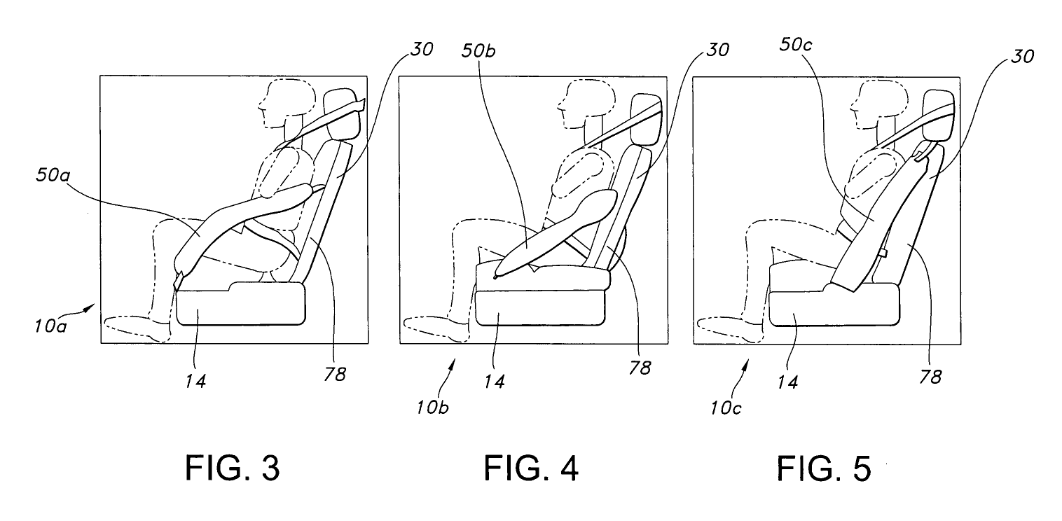

Illustrated respectively in FIGS. 3-5 are alternative systems 10a, 10b, and 10c. Each system 10a, 10b, and 10c remains attached to both seat bottom 14 and seat back 30, like system 10. Unlike system 10, however, systems 10a, 10b, and 10c are connected to out-board side 78, rather than in-board side 46, of seat back 30.

Systems 10a, 10b, and 10c additionally differ in their attachment points to seat platform 14 and seat back 30 and in the inflated shapes of component 50. System 10a, for example, may be connected to seat platform 14 farther forward than are systems 10b and 10c, while system 10c is attached to seat back 30 higher than are systems 10a and 10b. System 10a, further, may include a bend in its inflatable component (denoted 50a), and system 10b may have an inflatable component 50b of varying diameter along its length. Persons skilled in the art will, however, recognize that any of systems 10a, 10b, and 10c may be attached to a seat, shaped, and configured other than as illustrated in FIGS. 3-5. Nevertheless, if system 10b is as depicted in FIG. 4, it may serve to compensate for point-loading of ribs of occupant H, which may be caused by use by the occupant H of an armrest associated with the seat or by some other discontinuous profile thereof. System 10c, if as illustrated in FIG. 5, may tend to pre-load a shoulder of occupant H and distribute force along a substantial portion of the out-board side of the torso of occupant H.

Any or all of conventional sensors, actuators, inflators, charges, gas supplies, or gas generators may be employed in connection with any of systems 10, 10a, 10b, or 10c. Although not a present preference, any or all of inflatable components 50, 50a, and 50c may be vented if appropriate or desired. Moreover, any of systems 10, 10a, 10b, or 10c could be connected to the roof rail or other structure of a vehicle instead of attachment to either or both of seat platform 14 or seat back 30.

The foregoing is provided for purposes of illustrating, explaining, and describing exemplary embodiments and certain benefits of the present invention. Modifications and adaptations to the illustrated and described embodiments will be apparent to those skilled in the relevant art and may be made without departing from the scope or spirit of the invention.

What is claimed is:

1. Protective device for an occupant of a vehicle having a seat with a back and a platform, the protective device comprising an inflatable cushion (a) attached directly or indirectly to at least one of the back and platform and (b) that, when inflated, contacts and loads the occupant independent of and prior to the occupant experiencing significant forces caused by intrusion into the vehicle of a colliding object.

2. Protective device according to claim 1 in which the inflatable cushion, when inflated, reduces impact force to greater extent in at least one area of the occupant that is not especially force-tolerant.

3. Protective device according to claim 2 in which the reduced impact force is in the area of the abdomen or ribs of the occupant.

4. Protective device according to claim 1 in which, when inflated, the inflatable cushion moves the occupant laterally, in a direction generally away from the colliding object.

5. Protective device according to claim 4 in which, when inflated, the inflatable cushion contacts the pelvic region of the occupant so as to move the occupant in-board.

6. Protective device according to claim 4 in which, when inflated, the inflatable cushion moves the occupant in-board so as to decrease the relative velocity between the occupant and the colliding object.

7. Protective device according to claim 1 in which (a) the vehicle also has a roof rail and (b) the inflatable cushion is directly or indirectly attached to both the roof rail and the platform of the seat.

8. Protective device according to claim 1 in which the inflatable cushion is tubular and has first and second ends, further comprising a connector attached to each of the first and second ends.

9. Protective device according to claim 8 further comprising a cover for the inflatable cushion.

10. Vehicle seat assembly comprising:
a. a platform defining an area in which an occupant sits and having an in-board side and an out-board side;
b. a back directly or indirectly connected to the platform and having an in-board side and an out-board side; and
c. an inflatable system connected to the platform and which, when inflated, protrudes into the area in which the occupant sits.

11. Vehicle seat assembly according to claim 10 in which the inflatable system is connected to the out-board side of the platform.

12. Vehicle assembly according to claim 11 in which the inflatable system also is connected to the back at or near the in-board side of the back.

13. Vehicle assembly according to claim 12 in which the inflatable system comprises an inflatable cushion having a portion positioned within the back.

14. Vehicle assembly according to claim 10 in which the inflatable system comprises an inflatable, braided or knit cushion of generally tubular shape when inflated.

15. Vehicle assembly according to claim 14 in which, when inflated, the cushion decreases in length so as to create tension.

16. Vehicle assembly according to claim 10 in which, when inflated, the inflatable system contacts and pre-loads the occupant prior to the occupant experiencing significant forces caused by intrusion into the vehicle of a colliding object.

17. Vehicle assembly according to claim 10 in which the inflatable system, when inflated, reduces impact force to greater extent in at least one area of the occupant that is not especially force-tolerant.

18. Vehicle assembly according to claim 17 in which the reduced impact force is in the area of the abdomen or ribs of the occupant.

19. Vehicle assembly according to claim 16 in which, when inflated, the inflatable system moves the occupant laterally, in a direction generally away from a colliding object.

20. Vehicle assembly according to claim 19 in which, when inflated, the inflatable system contacts the pelvic region of the occupant so as to move the occupant in-board.

21. Vehicle assembly according to claim 19 in which, when inflated, the inflatable system moves the occupant in-board so as to decrease the relative velocity between the occupant and the colliding object.

22. Vehicle assembly according to claim 10 further comprising a roof rail and in which the inflatable system is attached thereto.

23. Protective device according to claim 1 in which the inflatable cushion is not vented.

24. Protective device according to claim 1 in which the inflatable cushion, when inflated, reduces overall peak loading of the occupant.

25. Protective device for an occupant of a vehicle having a seat with a back and a platform, the protective device comprising actuatable means, attached directly or indirectly to at least one of the back and platform, for contacting the pelvic region of the occupant so as to move the occupant in-board independent of the occupant experiencing significant forces caused by intrusion into the vehicle of a colliding object.

26. A method of deploying a protective device in a vehicle having a seat having an out-board side and an in-board side, the method comprising:
a. inflating a cushion of the protective device along at least a portion of the out-board side of the seat; and
b. contacting an occupant of the seat with the inflated cushion so as to pre-load the occupant prior to the occupant experiencing significant forces caused by intrusion into the vehicle of a colliding object.

27. A method according to claim 26 in which contacting the occupant of the seat with the inflated cushion comprises moving the occupant toward the in-board side of the seat.

28. A method according to claim 26 in which contacting the occupant of the seat with the inflated cushion comprises reducing impact force in the area of the ribs of the occupant.
